(19) United States
(12) Patent Application Publication
(10) Pub. No.: US 2004/0130105 A1
(43) Pub. Date: Jul. 8, 2004

(54) Chuck for securing a cutter in a machine

(76) Inventor: Jih-Ming Chen, Dali City (TW)

Correspondence Address: DELLETT AND WALTERS, P. O. BOX 2786, PORTLAND, OR, 97208-2786, US

(21) Appl. No.: 10/338,169

(22) Filed: Jan. 7, 2003

(51) Int. Cl. B23B 31/20

(52) U.S. Cl. 279/42

(57) ABSTRACT

A chuck for securing a cutter with a faceted end on a machine includes a body with a head, a retainer, a plug and a positioning device. The head has a tapered periphery, an external thread and a passage defined axially in the head. Three slots are defined radially through the head to divide the head into three clamping members. A tapered hole and a through hole with an internal thread are adjacently defined in the retainer. The cutter is inserted into the passage, and the plug is positioned in one of the slots to abut the faceted end of the cutter. As the retainer screws on the head tightly, the clamping members securely grip the cutter, and the plug holds the faceted end of the cutter in place so the cutter will not rotatably slip so accurate cuts can be made.

### BACKGROUND OF THE INVENTION

1. Field of the Invention

The present invention relates to a chuck, and more particularly to a chuck for securing a cutter in a machine to prevent the cutter from slipping in the chuck when the cutter is cutting.

2. Description of Related Art

Machines use cutters to form a workpiece into various shapes, sizes and dimensions. For example, drilling machine uses a drill bit to make a hole in an object, tapping machine uses a tapping bit to make a threaded hole in an object. The machine generally includes a chuck to hold the drill bit or cutter. The drill bit is round and may rotatably slip when the drill is drilling. Rotatably slipping prevents the bit from drilling or tapping precisely.

Also, chucks available today have a complex structure to keep the cutter from slipping and are expensive. Installing and adjusting the conventional chuck in a machine is inconvenient because of its complex structure.

To overcome the shortcomings, the present invention provides a chuck to secure a cutter in a machine to mitigate or obviate the aforementioned problems.

### SUMMARY OF THE INVENTION

The main objective of the invention is to provide a simple chuck for securing a cutter in a machine, which keeps the cutter from rotatably slipping in the chuck.

Another objective of the invention is to provide a cheap chuck for securing a cutter in a machine, which will meet precise machining requirements.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a chuck in accordance with the present invention;

FIG. 2 is an exploded side plan view in partial section of the chuck in FIG. 1; and

FIG. 3 is a side plan view in partial section of the chuck in FIG. 1.

### DETAILED DESCRIPTION OF PREFERRED EMBODIMENT

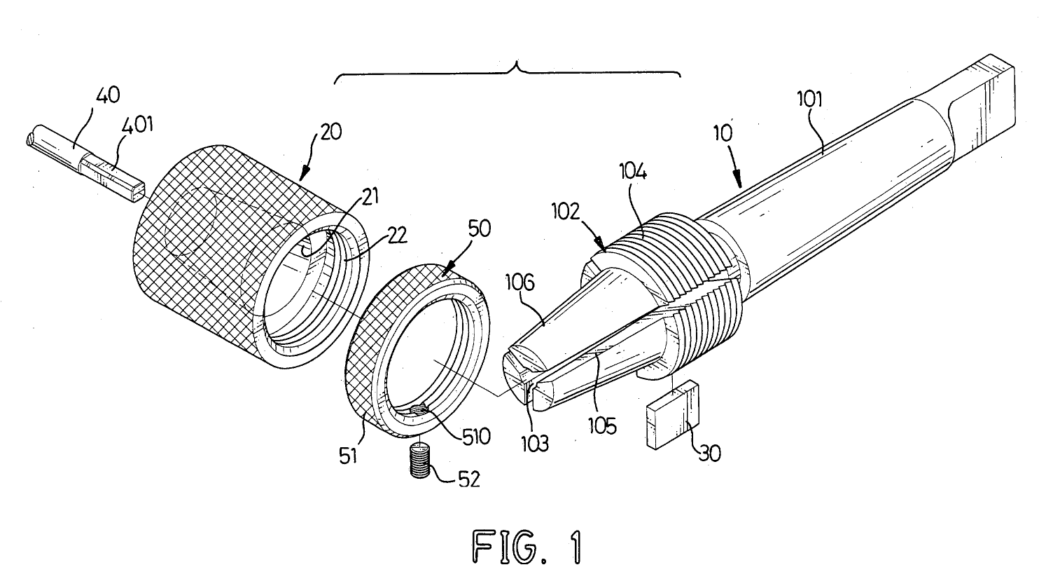

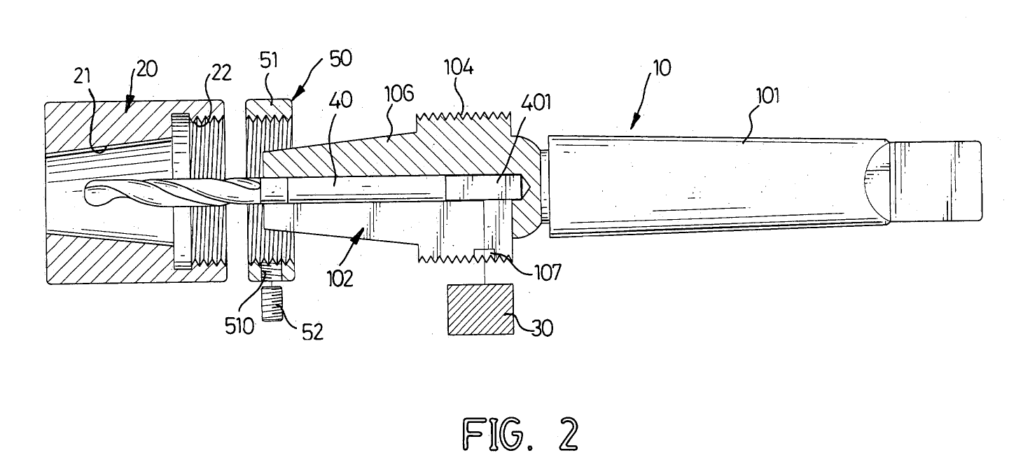

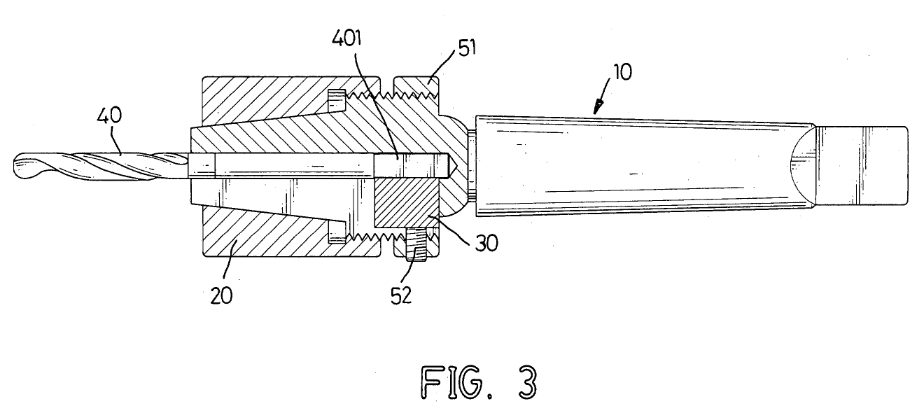

With reference to FIGS. 1 to 3, a chuck in accordance with the present invention includes a body (10), a retainer (20), a plug (30) and a positioning device (50). The body (10) has a shaft (101) and a head (102). The shaft (101) has a proximal end (not numbered) and a distal end (not numbered). The proximal end of the shaft (101) can be connected securely to a machine (not shown) such as a drill press (not shown). The head (102) is formed on the distal end of the shaft (101) and has a distal end (not numbered), a tapered periphery (not numbered), a passage (103) defined axially in the distal end of the head (102) and an external thread (104). The tapered periphery is formed near the distal end of the head (102), and the external thread (104) is defined on the head (102) adjacent to the tapered periphery of the head (102). Three slots (105) are defined radially through the head (102) from the passage (103) to the tapered periphery and the external thread (104) and divide the head (102) at the tapered periphery into three clamping members (106). People skilled in the art should recognize that more than three clamping members (106) can be used. A set hole (107) corresponding to one slot (105) is defined through the external thread (104) on the head (102).

A tapered hole (21) corresponding to the tapered periphery of the head (102) is defined axially in the retainer (20). A through hole (not numbered) with an internal thread (22) corresponding to the external thread (104) on the head (102) is defined axially in the container (20) and communicates with the tapered hole (21). The internal thread (22) screws onto the external thread (104), and the tapered hole (21) presses the clamping members (106) together.

A cutter (40) with a faceted end (401) used for a drilling, tapping, routing or milling machine is inserted in the passage (103) in the head (102). The plug (30) with an inside edge (not numbered) and an outside edge (not numbered) is inserted into one of the three slots (105) corresponding to the set hole (107), and the inside edge of the plug (30) abuts the faceted end (401) of the cutter (40). To exactly position the plug (30) in the slot (105), the positioning device (50) is attached to the head (102) corresponding to the plug (30). The positioning device (50) includes a nut (51) and a setscrew (52) with an end (not numbered). A setscrew hole (510) corresponding to the set hole (107) is defined radially in the nut (51). The nut (51) is screwed on the external thread (104) of the head (102), and the setscrew hole (510) of the nut (51) is aligned with the set hole (107) in the head (102). The setscrew (52) is screwed through the setscrew hole (510) in the positioning device (50) and the set hole (107) in the head (102) such that the end of the setscrew (52) abuts the outside edge of the plug (30). Such a structure prevents the plug (30) from coming out of the slot (105) when the chuck is rotating.

The retainer (20) is screwed onto the external thread (104) of the head (102) to keep the plug (30) from axially coming out of the slot (105) and squeezes the clamping members (106) toward the passage (103) to securely hold a cutter (40) in the chuck.

Therefor, the chuck is able to prevent the cutter (40) from rotatably slipping when the cutter (40) is drilling, tapping, routing or milling, because the plug (30) is positioned in place and abuts the faceted end (410) of the cutter (40). The chuck can securely hold the cutter (40) in the machine to make accurate cuts, has a simple structure for convenient use and is cheap.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chuck for securing a cutter in a machine, and the chuck comprising:
a body comprising
a shaft with a proximal end and a distal end, and the proximal end of the shaft adapted to be connected to a machine; and
a head formed from the distal end of the shaft and the head having
a distal end;
a passage defined axially through the distal end of the head and adapted to receive a faceted end of the cutter;
a tapered periphery formed near the distal end of the head;
an external thread formed on the head adjacent to the tapered periphery of the head;
at least three slots defined through the head from the passage to the tapered periphery and the external thread of the head, and dividing the head at the tapered periphery into at least three clamping members; and
a set hole defined corresponding to one of the at least three slots through the external thread of the head;
a retainer mounted on the head of the body and the retainer having
a tapered hole defined axially in the retainer and corresponding to the tapered periphery of the head; and
a through hole with an internal thread corresponding to the external thread on the head defined in the retainer and communicating and aligning with the tapered hole;
a plug with an inside edge and an outside edge mounted in one of the at least three slots corresponding to the set hole in the head, and the inside edge of the plug adapted to abut the faceted end of the cutter; and
a positioning device screwed on the external thread of the head and the positioning device comprising
a nut with a setscrew hole used to align with the set hole in the head screwed on the external thread of the head; and
a setscrew with an end screwed into the setscrew hole in the positioning device and passed through the set hole in the head, and the end of the setscrew abutting the outside edge of the plug;
whereby as the retainer screws tightly onto the head, the at least three clamping members are squeezed together to secure the cutter and the plug to hold the cutter in place.
